(19) United States
(12) Patent Application Publication
(10) Pub. No.: US 2008/0287234 A1
(43) Pub. Date: Nov. 20, 2008

(54) Belt Drive

(75) Inventors: Roman Kern, Forchheim (DE); Rainer Pflug, Heilsbronn (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/094,292

(22) PCT Filed: Nov. 7, 2006
(86) PCT No.: PCT/EP2006/068168

§ 371 Date: May 20, 2008

(30) Foreign Application Priority Data
Nov. 23, 2005 (DE) 10 2005 055 716.3

(51) Int. Cl. F16H 7/08

(52) U.S. Cl. 474/133

(57) ABSTRACT

A belt drive (1) including a belt drive element (4) such as a belt or a chain and a plurality of wheels (1, 6, 7, 8) seated on shafts and integrated into the drive, around which the belt drive element is wound. Parasitic oscillations are introduced into the belt drive (1) by at least one shaft. For the purpose of generating a counter-oscillation, at least one wheel (3) has a non-circular shape. The non-circular wheel (3) is configured, in terms of its shape, in such a manner that it is adapted to generate a counter-oscillation which compensates at least two different main oscillation orders of the parasitic oscillation.

### BACKGROUND

The invention relates to a belt drive comprising a looped element, such as a belt or a chain, and several wheels, which are integrated in the drive and around which the looped element is wound and which sit on shafts, wherein parasitic oscillations are introduced into the belt drive via at least one shaft and wherein, for generating a counter oscillation, at least one wheel has a non-round shape.

Such belt drives are typically used for internal combustion engines primarily in the automotive industry. The drive is typically driven by a wheel seated on a crankshaft. Through the use of the traction element, e.g., a belt, one or more camshafts, for example, on which corresponding drive wheels similarly are seated, are driven, just like other additional components, such as, e.g., a water pump, an air-conditioner compressor, etc., can be incorporated into the drive via corresponding wheels and driven by this drive.

Due to the operation of the internal combustion engine, which typically involves a reciprocating piston engine, oscillations are transferred to the drive via the crankshaft, that is, oscillations are stimulated in the looped element, such as, for example, the belt, due to non-uniform rotation, fluctuations in rotational moment, or changes in angular velocity, which is disadvantageous and shortens the service life and negatively affects efficiency. In addition to the parasitic oscillations introduced via the crankshaft, parasitic oscillations also can be introduced, for example, via a camshaft. The camshaft typically drives the valves. From this timing control, non-uniform rotation and fluctuations in rotational moment can also be fed back to the camshaft through the valve drive, which can be introduced as parasitic oscillations in the belt drive.

This finally leads to the result that the belt drive oscillates, typically generating a characteristic oscillation pattern.

In order to reduce or damp these oscillations, it is known, for example, from DE 195 20 508 A1 to form one of the wheels integrated in the drive, for example, the crankshaft wheel, with a non-round, e.g., oval shape. Due to this non-round geometry, counter oscillations are generated, according to which this non-round shape causes a defined lengthening and shortening of the traction element for each rotation of the shaft. These counter oscillations are superimposed on the introduced parasitic oscillations and reduce or compensate these parasitic oscillations.

The shape of the non-round wheel is here selected as a function of a main oscillation order to be damped in the superimposed parasitic oscillations. The parasitic oscillations are typically composed of individual oscillations of different orders, that is, the measurable oscillation spectrum can be resolved into individual main oscillation orders. With known, non-round wheels, a main oscillation order is damped selectively, in order to steady the drive. Even though this leads to noticeable steadying of the drive, residual parasitic oscillations nevertheless remain.

### SUMMARY

Thus, the invention is based on the objective of providing a belt drive, in which means are provided for further steadying the drive.

For meeting this objective, in a belt drive of the type noted above it is provided according to the invention that the non-round wheel is constructed with a shape in such a way that a counter oscillation can be generated, which compensates at least two different main oscillation orders of the parasitic oscillations.

The invention is based on the idea that not only one main oscillation order of the parasitic oscillation, but also at least two or more orders, are damped by a single non-round wheel. It has been established that when only one main oscillation order or dominant oscillation order is damped, residual parasitic oscillations still remain, which consist of the non-damped oscillation components. According to the invention, now the geometry of the non-round wheel is constructed in such a way that at least one additional main oscillation order of the parasitic oscillations can be damped. In this way a counter oscillation is generated, which is composed of two generated counter main oscillation orders defined based on the wheel geometry and superimposed one on the other and which counteracts the corresponding main oscillation orders of the parasitic oscillation and compensates for the parasitic oscillation as much as possible. In this way, under the use of only one wheel, more significant steadying of the drive can be achieved than for previously known drives, in which only one main oscillation order of the parasitic oscillation is damped by a non-round wheel.

The form of the non-round wheel is obtained according to the invention by superimposing two different geometries related to the main oscillation orders to be compensated in the parasitic oscillation. For example, if the third and the fourth main oscillation orders or dominant oscillations of the parasitic oscillation are to be compensated, then triangular and quadrangular shapes are superimposed for defining the wheel geometry. The superimposition is realized in such a way that the counter oscillation generated with the resulting non-round wheel exhibits an oscillation pattern that corresponds to the parasitic oscillation pattern but has a mirror-symmetric profile. For this purpose, it is advantageous when the changes in radius of the wheel, which are given by the superimposition or non-round shape, are defined as a function of the amplitude of the parasitic oscillation. In this way it is guaranteed that the counter oscillation corresponds in amplitude to the parasitic oscillation, so that this is almost completely canceled in the most favorable case. Furthermore, it is naturally advantageous when the shape of the wheel is defined as a function of the phase angle of the amplitudes of the main oscillation orders to be compensated, in order to guarantee that, with respect to the parasitic oscillation to be damped, the counter main oscillations are also generated in-phase with respect to the main oscillations to be damped.

Finally, an especially advantageous construction of the invention is provided in that the wheel has a positive radius over the entire periphery. That is, the geometry is defined or constructed by superimposing the individual geometries in such a way that no depressions are produced, in which there is a negative radius, and in which areas the traction element cannot become stuck to the non-round wheel. In this way, it is guaranteed that the traction element is wound around the wheel to a maximum possible extent independent of the position of the wheel and optimum moment transfer is possible.

### BRIEF DESCRIPTION OF THE DRAWINGS

Additional advantages, features, and details of the invention emerge from the following description of the embodiments. Shown are:

FIG. 1 is a schematic diagram of a belt drive according to the invention,

FIG. 2 is a schematic diagram of the parasitic oscillation introduced via the internal combustion engine via the crankshaft and composed, as an example, from the third and fourth main oscillation orders.

FIG. 3 is a diagram of the two resolved third and fourth main oscillation orders, which, in superimposition, produce the parasitic oscillations according to FIG. 2,

FIG. 4 is a schematic diagram of a non-round wheel shaped according to the invention for generating counter oscillations for compensating the third and fourth main oscillation orders of the parasitic oscillation from FIG. 3,

FIG. 5 is a diagram showing the counter oscillation that can be generated by the wheel according to FIG. 4, shown merely as an example for the third and fourth main orders of the counter oscillation, and

FIG. 6 is a diagram of the two resolved third and fourth main orders of the counter oscillation, which, in superimposition, lead to the counter oscillation according to FIG. 5.

### DETAILED DESCRIPTION OF THE PREFERRED EMBODIMENTS

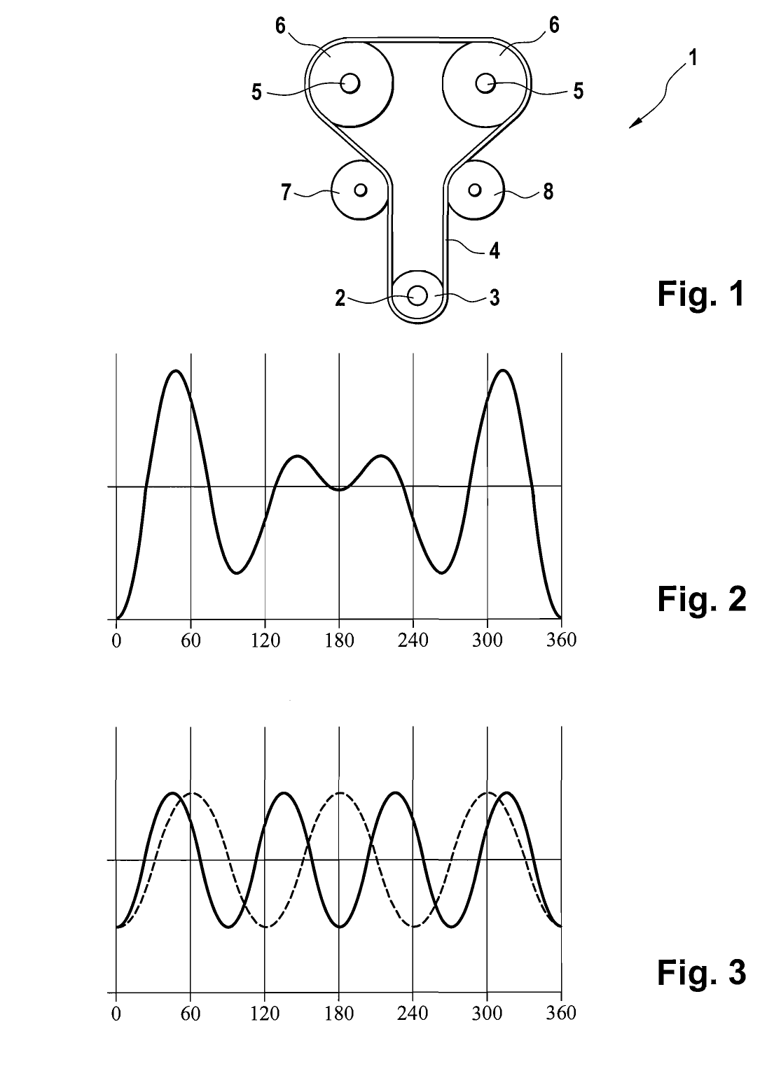

FIG. 1 shows, in the form of a schematic diagram, a typical belt drive 1 as provided, for example, in an internal combustion engine of a motor vehicle engine. A first wheel 3, around which traction element 4 or a belt or a chain is wound, sits on a crankshaft 2. A wheel 6, around which traction element 4 is similarly wound, also sits on each of two camshafts 5. Furthermore, there is a tensioning device 7, which can involve a tensioning roller, if the traction element 4 involves a belt. If the traction element 4 involves a chain, then the tensioning device 7 is constructed as a tensioning rail. On the opposite section of the traction element 4 there is a guide device 8, by which the traction element 4 is guided. For a belt, the guide device 8 involves a deflection roller. In the case of a chain, the guide device involves a guide rail. The basic setup of a belt drive has been known for a long time and does not require a more detailed explanation.

During operation, parasitic oscillations are now coupled into the belt drive 1 or the traction element 4 both via the crankshaft 2 and also via the camshafts 5, which lead to oscillation of the traction element 4. The parasitic oscillations coupled via the crankshaft 2 results from the operation of the internal combustion engine, that is, the engine itself, as a result finally from the reciprocating motion. The parasitic oscillations, which are introduced via the camshafts 5, result from the valve driving realized by the camshafts 5.

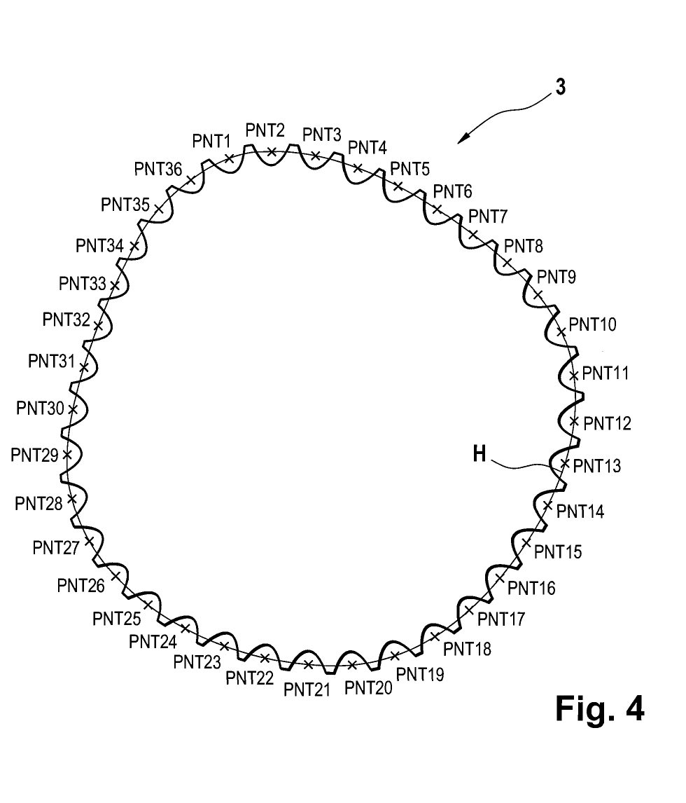

For compensating the parasitic oscillations, in the illustrated embodiment the wheel 3 on the crankshaft 2 has a non-round construction, wherein this is represented as an example by an oval form of the wheel 3. A real form of such a wheel, as constructed according to the invention, is shown in FIG. 4, which will be discussed in more detail below. Through the use of this non-round wheel, counter oscillations can now be generated, which are introduced intentionally and actively into the traction element 4 and which are designed in such a way that the parasitic oscillations are damped.

The parasitic oscillation spectrum as it really appears in such a belt drive can be measured. With reference to the measured oscillation profile, the spectrum can be resolved into individual oscillation components of various main oscillation orders or dominant oscillations. Typically, a non-round wheel is designed for compensating a single main oscillation. The parasitic oscillation spectrum, however, is assembled as described from several dominant oscillations or main oscillation orders, so that the damping of one main oscillation does indeed produce steadying, but residual oscillation still remains.

FIG. 2 shows as a schematic diagram an example of a parasitic oscillation profile, wherein this parasitic oscillation is composed in the embodiment from third and fourth order main oscillations, which are here superimposed. This parasitic oscillation is introduced into the traction element via the engine or the crankshaft. It is obvious that significant oscillation amplitudes, consequently fluctuations in moment or force, are produced in the traction element. The parasitic oscillation, as shown in FIG. 2, can be resolved into the two main oscillation orders, as shown in FIG. 3. Using the dashed line, the third order main oscillation is shown, while the solid line shows the fourth order main oscillation. If these two oscillations are superimposed on each other, then the parasitic oscillation profile shown in FIG. 2 is produced.

According to the invention, through the use of a single wheel both the third order main oscillation and also the fourth order main oscillation are now damped. For this purpose, the shape or geometry of the non-round wheel 3 is constructed in such a way that counter oscillations are generated, which exhibit an oscillation spectrum—idealized for the present embodiment—that is opposite the spectrum according to FIG. 2 in terms of amplitude profile and that is similarly formed from dominant third and fourth order counter oscillations. Such a wheel is shown as an example in FIG. 4. This wheel is obviously not round; it has an irregular peripheral shape that is obtained, in the shown example, by superimposing triangular and quadrangular wheel geometries. The triangular wheel geometry is used for generating third order counter oscillations, while the quadrangular wheel geometry is used for generating fourth order counter oscillations. The superimposition of these wheel geometries leads to the wheel shape shown in FIG. 4, wherein, in the scope of the superimposition, first the phase angle, which the individual orders have relative to each other, and second, with respect to the fluctuations in radius, the amplitudes of the individual oscillation orders are taken into consideration.

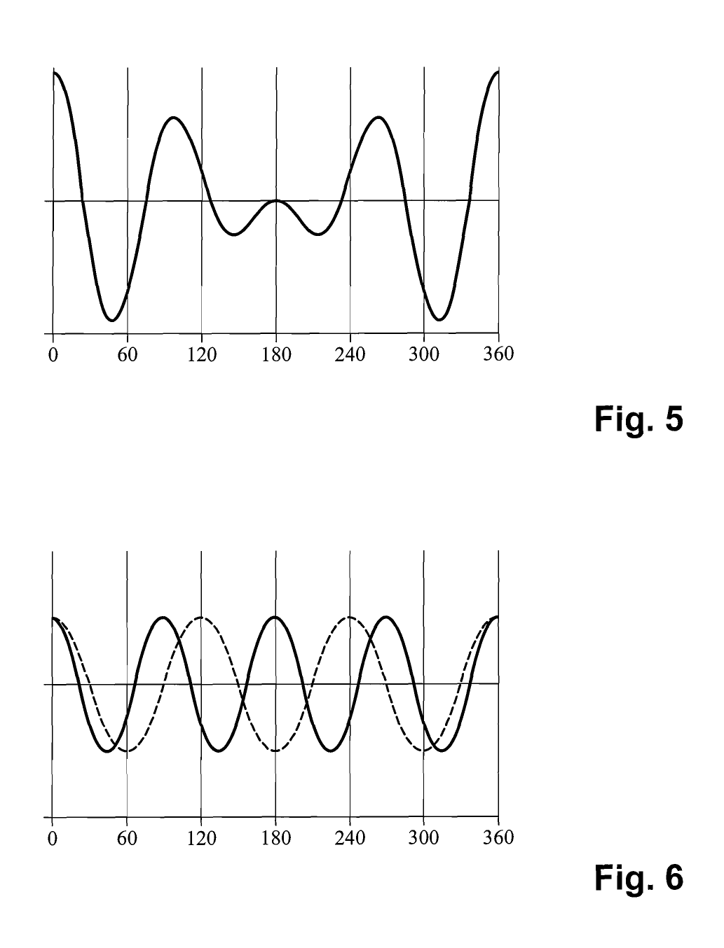

With the wheel, as shown in FIG. 4, in particular the third and fourth order main oscillations, as shown in FIG. 6, which lead, in superimposition, to the counter oscillation spectrum as shown in FIG. 5, can be generated—naturally in addition to oscillations of other orders—wherein, in the idealized embodiment, this counter oscillation spectrum is also generated merely from these two oscillation orders.

Obviously, in terms of amplitude the counter oscillation spectrum counteracts the parasitic oscillation spectrum according to FIG. 2, but the individual amplitudes are in-phase. If this counter oscillation were now superimposed on the parasitic oscillation, then ideally it would result in a complete cancellation of oscillations.

As discussed, the shape of the wheel 3, as shown in FIG. 4, is now obtained by superimposing the two geometries (triangle and quadrangle) related to the main oscillation orders to be compensated, namely here the third and fourth order, under consideration of the amplitudes and phase angle. Referencing the individual peripheral sections of the wheel according to FIG. 4 to the counter oscillation spectrum according to FIG. 5 is possible via the points along the envelope curve H designated as a whole with 36 and labeled PNT 1 . . . PNT 36. Each point corresponds to a 10° marking along the abscissa in FIG. 5, along which the rotational angle of the wheel 3 or the crankshaft 2 is plotted for a 360° rotation. Consequently, the point PNT 1 corresponds to 0° vertical, the point PNT 2 corresponds to 10° vertical, the point PNT 3 corresponds to 20° vertical, etc. In the present case, this means that when the point PNT 1 points vertically downward in the shown embodiment according to FIG. 2, thus it is enclosed completely and essentially in the middle by the traction element 4, a counter oscillation is generated with a maximum amplitude, see FIG. 5. With increasing rotation of the wheel, the wheel radius decreases, that is, the traction element length or the force introduced into the traction element via the wheel shape decreases, consequently the amplitude of the counter oscillation also decreases. In the region of ca. 40° rotation of the wheel 3, the point PNT 5 is located in the lowermost position. This point lies in a region with a small radius, which is why the counter oscillation amplitude is consequently small. For further rotation of the chain wheel up to the point PNT 10 (90° vertical), the radius increases, in turn, which results in a corresponding characteristic in the counter oscillation diagram. Correspondingly, each of the points PNT 1-PNT 36 can be referenced to the counter oscillation spectrum according to FIG. 5.

Thus it is obviously possible to generate a counter oscillation, which was generated by the superimposition of two actively generated main oscillation orders—in the example third and fourth order—under use of only one non-round wheel—here a chain wheel—wherein the wheel is designed as a function of the measured actual parasitic oscillation spectrum. Here, first, the amplitude of the parasitic oscillation or the fluctuation in force is to be considered, which results in the fluctuations of the radius of the wheel. The order number of the fluctuations in force, whether involving parasitic oscillations of second, third, or fourth order to be damped, results in the non-round shape, because as a function of the order to be damped, the corresponding triangular, quadrangular, pentagonal, etc. geometry is to be selected and superimposed with the geometry of the other main oscillation order to be damped. Finally, the phase angle of the parasitic oscillations or fluctuations in force relative to each other, resolved according to each main oscillation order, is produced, from which each rotational position of the non-round shapes results, because in this way it is guaranteed that the individual main oscillation orders are generated in-phase, so that the resulting counter oscillation spectrum corresponds to the greatest extent to the parasitic oscillation spectrum—related to the main oscillation orders to be damped.

As FIG. 4 further shows, the design of the wheel geometry is such that a positive radius is given at each position of the wheel periphery, that is, the radius is never negative, so no depressions are given, in which the traction element—in the shown example this was a chain—could become stuck to the wheel. Instead, the traction element is fixed in each rotational wheel position with the maximum possible contact or belt wrap on the wheel 3.

### REFERENCE NUMBERS

1 Belt drive
2 Crankshaft
3 First wheel
4 Traction element
5 Camshafts
6 Wheel
7 Tensioning device
8 Guide device
H Envelope curve

1. Belt drive comprising a looped element and several wheels, which are integrated in the drive and around which the looped element is wound and which sit on shafts, wherein parasitic oscillations are introduced into the belt drive via at least one shaft, and wherein, for generating a counter oscillation, at least one of the wheels has a non-round shape, the shape of the non-round wheel is constructed so that the counter oscillation is generated that compensates at least two different main oscillation orders of the parasitic oscillations.

2. Belt drive according to claim 1, wherein the shape of the wheel is obtained by superimposing two different geometries related to primary ones of the oscillation orders to be compensated.

3. Belt drive according to claim 1, wherein changes in radius on the wheel are defined as a function of an amplitude of the parasitic oscillations.

4. Belt drive according to claim 3, wherein the shape of the wheel is defined as a function of a phase angle of amplitudes of primary ones of the oscillation orders to be compensated.

5. Belt drive according to claim 1, wherein the wheel has a positive radius across an entire periphery thereof.
